(19) United States
(12) Patent Application Publication
(10) Pub. No.: US 2008/0297115 A1
(43) Pub. Date: Dec. 4, 2008

(54) Device Using Residual Energy of a Battery

(75) Inventors: George Gallagher, Caerwys (GB); Hal Danby, Suffolk (GB)

Correspondence Address: CHARLES N. QUINN;FOX ROTHSCHILD LLP, 2000 MARKET STREET, 10TH FLOOR, PHILADELPHIA, PA, 19103, US

(73) Assignee: ZI MEDICAL PLC, St. Asaph (GB)

(21) Appl. No.: 11/664,866

(22) PCT Filed: Sep. 30, 2005
(86) PCT No.: PCT/GB05/03790

§ 371 Date: May 28, 2008

(30) Foreign Application Priority Data
Oct. 6, 2004 (GB) 0422283.2

(51) Int. Cl. H02J 7/00

(52) U.S. Cl. 320/136

(57) ABSTRACT

Control means (22) for a battery (20) for powering a load (18) wherein the battery is connected via switching means (24) to the load. The control means is able to ascertain when the remaining battery life is below a predetermined level and commands the switching means to disconnect the battery before it is fully discharged. A manual override (30) enables the battery to be reconnected to the load (18) to make use of the remaining battery life.

The present invention relates to reserve power for a battery.

Batteries are used in many applications for providing a convenient source of power to electrical devices. A disadvantage of using battery power, rather than mains power is that battery life can be limited. More importantly, however, especially where rechargeable batteries are used, battery life can be unpredictable.

Various battery-monitoring devices are available for determining the amount of available power left in a battery. Such devices can provide warning signals to warn a user when the amount of remaining power is low. The user can then opt to recharge or replace the battery, or to conserve power if possible.

In certain critical applications, e.g. in portable medical devices, if a battery runs flat, then there may be catastrophic consequences. A problem with known battery monitors is that they produce a warning signal that is either not noticed or heeded. Such a situation cannot be tolerated when it comes to operating portable medical devices.

The present invention aims to provide a solution to one or more of the above problems.

Accordingly, a first aspect of the present invention provides a control means for a battery for powering a load comprising; sensing means for sensing one or more properties of the battery to ascertain its charge condition; and switch means for selectively connecting and disconnecting the battery from the load; wherein the switch means is adapted to disconnect the battery when the sensing means senses that the status of the battery falls below a predetermined level; and wherein manual reconnection of the load is possible to permit further use of the battery, the predetermined level being such that the battery is not fully discharged.

A second aspect of the invention provides a method of controlling a battery for powering a load comprising the steps of sensing one or more properties of the battery to ascertain its charge condition and selectively connecting and disconnecting the battery from the load, the method being characterised in that switching occurs upon sensing that the status of the battery has fallen below a predetermined level and wherein manual reconnection of the load is possible to permit further use of the battery, the predetermined level being such that the battery is not fully discharged.

A possible advantage of the invention is such that the control means may emit warning signals to warn the user that the battery charge status is low, but if those warnings are not heeded, i.e. the battery replaced or recharged, then the battery will be disconnected. This will prompt the user to have to invoke a manual override to reconnect the battery, reminding him or her of the urgency of battery attention.

The control means of the invention preferably comprises a circuit. The load may be of any type One possible application of the invention, however, sees the load being a medical device, e.g. a syringe driver.

The sensing means of the invention is capable of sensing one or more properties of the battery to ascertain its charge condition. The battery properties sensed may one or more of the following: voltage, current, temperature, internal resistance, capacitance, time in use, cumulative time of use since new, time since last charge.

The sensing means may also be adapted to monitor certain characteristics of the load, e.g. its resistance, capacitance, temperature, power consumption etc.

In a preferred embodiment of the invention, the sensing means takes an instantaneous voltage reading from the battery and reads it off against a look-up table readable by the sensing means. The look-up table, where provided, may be generic or battery-specific. By using the look-up table, the sensing means it preferable able to determine where on a known voltage-time characteristic curve the battery is, and hence, the time remaining before the battery will become substantially discharged.

As previously stated, a further preferred feature of the invention is that it senses certain characteristics of the load. Thus, the sensing means may be able to modify its estimate of battery life remaining based on the load characteristics.

For example, the sensing means may determine that there is 2 hours remaining battery life based on a power consumption of 100 mW. However, should the load double, the power consumption of the load would double to 200 mW, and the sensing mans could revise its estimate of remaining battery life accordingly; i.e. to 1 hour.

The look-up table, where provided, may be of any practical type. In one possible embodiment of the invention, the look-up table is stored in memory within the sensing means. However, it is possible that the look-up table be removable, e.g. in the form of a removable SIM card, or ROM chip. Additionally or alternatively, the look-up table may be carried by the battery.

In a further possible embodiment of the invention, the sensing means is capable of conducting one or more characterising tests on the battery to determine its type (i.e. PbH₂SO₄, NiMH, NiCd, etc.) and its capacity (100 mAh, 500 mAh, 1200 mAh, etc.). The sensing means may have access to a bank of look-up tables, one of which is selected based on the sensing means' determination of the battery type.

The switch means for selectively connecting and disconnecting the battery from the load may be of any suitable type. A transistor-based switching means is envisaged to be the most practical, e.g. a FET-based switch. Where a high voltage or current is to be switched, a relay may be employed.

The predetermined level is such that the further use of the battery is possible after reconnection. It is envisaged that the predetermined level should coincide with a suitable remaining battery life, e.g. switch off when 1-hour's battery life remains. This should prompt the user that urgent battery attention is required, whilst providing adequate time to action that required attention. The predetermined level is such that the battery is not fully discharged when switching takes place.

A preferred embodiment of the invention shall now be described, by way of example only, with reference to the accompanying drawings, in which;

FIG. 1 shows a view of a syringe driver according to the invention;

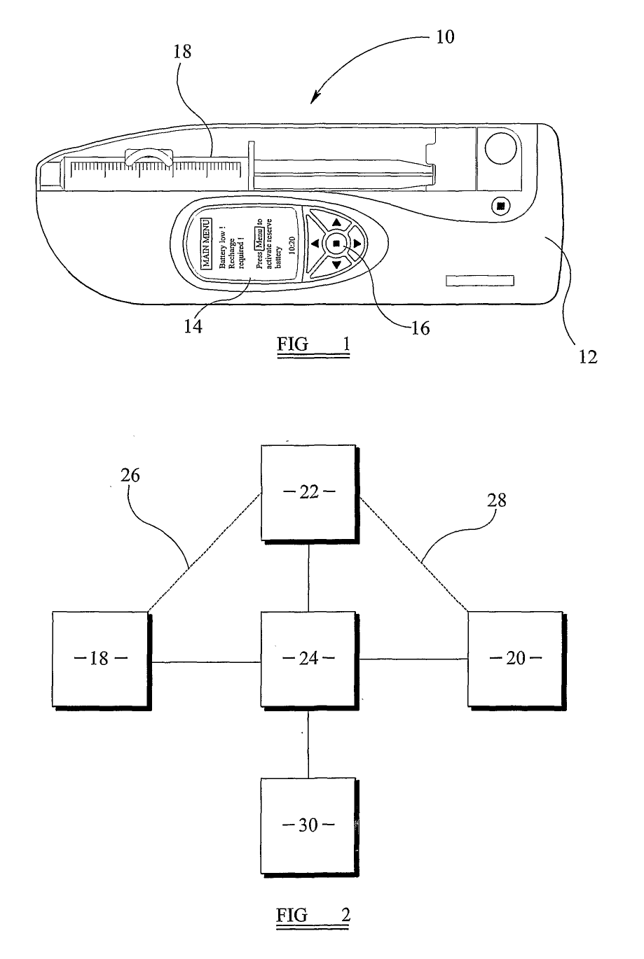

FIG. 2 shows a system schematic of the invention;

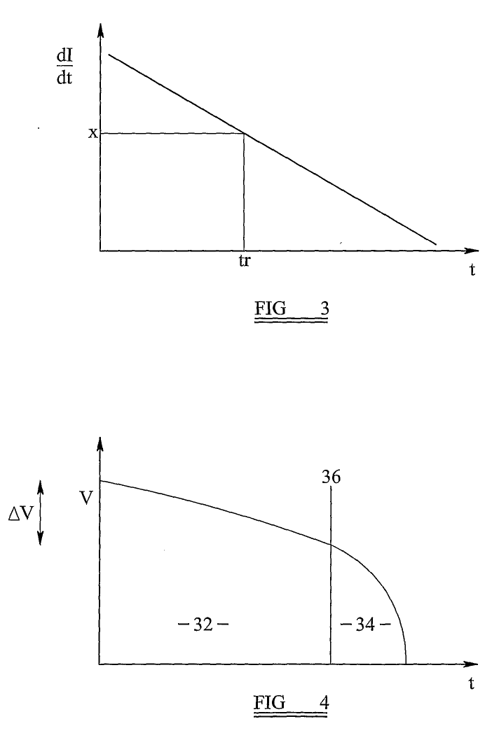

FIG. 3 shows a schematic plot of battery life versus rate of change of available current; and

FIG. 4 shows a schematic plot of available battery voltage versus time.

Referring now to FIGS. 1 and 2, a syringe driver 10 incorporating the invention is shown comprising a body 12 for housing a syringe and driver mechanism 18 therefor. The body has a display screen 14 and cursor and selection keys 16. The syringe driver can be programmed and controlled using menu-driven control software via the screen 14 and keys 16.

The syringe driver 10 is adapted to operate according to a user-definable regime under battery 20 power. An inductive charger unit (not shown) is provided for recharging an integral rechargeable battery 20. When the remaining battery power becomes low, the screen 14 displays a message indicating that a recharge is required, and the screen's backlight flashes to draw attention thereto. An audible signal is also provided.

When the remaining battery life falls below a predetermined level, a control means 22 instructs a switching means 24 to disconnect the battery 20 from the load 18 (i.e. the syringe driver mechanism).

FIG. 2 shows a system schematic of the invention 1O, wherein a battery 20 is connected via a switching means 24 to a load 18. Sensing means comprising a control means 22 (e.g. a microprocessor) and sensors 26 & 28 monitors the state of the battery 20 and load 18, either continuously or periodically.

When the control means 22 ascertains that the remaining battery life is below a predetermined level, it commands the switching means 24 to disconnect the load 18 from the battery 20.

A manual override 30 is provided that enables the battery 20 to be reconnected to the load 18 to make use of the remaining battery life. The manual override is activated, in the present embodiment, by following an on-screen 14 instruction (e.g. “. . . press the menu key to activate reserve battery . . . ”).

Turing now to FIG. 3, the control means can determine the remaining battery life by referring to a look-up table stored in memory. Fore example, a characteristic feature of the battery may be that the remaining battery life tᵣ (e.g. in hours) can calculated from the rate of change of available current I.

For example, FIG. 4 shows how the battery voltage V decreases over time t. There is a first linear region 32 and a second tail-off region 34. The change of voltage ΔV over most of the battery's operational cycle is quite small, but with a sudden drop towards the end of its life. Thus, for a given load, which can be monitored by the sensing means 26, the available current (i.e. the available voltage divided by the applied load) can be ascertained.

The rate of change of available current, dI/dt, varies as a function of time. Thus, the interface 36 between the linear 32 to tail-off 34 regimes can be predicted when dI/dt falls to a predetermined value x.

Thus, in the present example, the system is configured to monitor the battery voltage V and the applied load, and to determine therefrom, the operating current I. The operating current I is monitored as a function of time t, and when the rate of change of current dI/dt reaches a predetermined level x, the control means disconnects the battery 20 from the load 18. A warning signal is then displayed, which prompts the user to manually reconnect the battery 20 to the load 18 using keypad controls.

In this way, the likelihood of the battery becoming completely discharged is reduced, as the user receives audible and visual warnings relating to the battery condition. Those warnings can be ignored or overlooked for a period of time, but if the remaining battery life falls below a predetermined level, then direct user intervention is required, which prompts urgent action (e.g. recharging) on the part of the user.

Alternative means of achieving the same result may be employed, and may be well known to those of skill in the art e.g. by monitoring different battery and/or load properties, providing an alternative manual override etc. For example, it is possible that the load power used be monitored and subtracted from the last known remaining battery power (i.e. when the battery is fully charged) to ascertain the battery life remaining. This “dead reckoning” approach could be periodically updated with reference to “on the fly” monitoring to provide a double check or to obtain a more accurate estimate of remaining battery life.

1. A battery-operated medical device having a battery for powering the device, the battery-operated medical device comprising sensing means for sensing one or more properties of the battery to ascertain its charge condition; and switch means for selectively connecting and disconnecting the battery from the device; wherein the switch means is adapted to disconnect the battery when the sensing means senses that the battery falls below a predetermined level; and wherein manual reconnection of the medical device is possible to permit further use of the battery, the predetermined level being such that the battery is not fully discharged.

2. A battery-operated medical device as claimed in claim 1, wherein the battery-operated medical device emits a warning signal to warn the user that the battery status is low prior to disconnection of the battery.

3. A battery-operated medical device as claimed in claim 1 wherein the battery-operated medical device comprises a circuit.

4. (canceled)

5. A battery-operated medical device as claimed in claim 3 wherein the medical device is a syringe driver.

6. A battery-operated medical device as claimed in claim 5 wherein the battery property sensed by the sensing means is one or more of the group selected from voltage, current, temperature, internal resistance, capacitance, time in use, cumulative time of use since new and time since last charge.

7. A battery-operated medical device as claimed in claim 6 wherein the sensing means takes an instantaneous voltage reading from the battery and reads it off against a look-up table readable by the sensing means.

8. A battery-operated medical device as claimed in claim 7 wherein the look-up table is generic or battery-specific.

9. A battery-operated medical device as claimed in claim 8 wherein the sensing means is able to determine where on a known voltage-time characteristic curve the battery is and thereby determine the time remaining before the battery will be substantially discharged.

10. A battery-operated medical device as claimed in claim 9 wherein the sensing means is able to modify its estimate of battery life based on characteristics of the load.

11. A battery-operated medical device as claimed claim 10 wherein the look-up table is stored in memory within the sensing means.

12. A battery-operated medical device as claimed in claim 10 wherein the look-up table is removable.

13. A battery-operated medical device as claimed in claim 10 wherein the look-up table is carried by the battery.

14. A battery-operated medical device as claimed in claim 13 wherein the sensing means is capable of conducting one or more characterizing tests on the battery to determine its type and/or its capacity.

15. A battery-operated medical device as claimed in claim 14 wherein the sensing means has access to a bank of look-up tables, one of which is selected based on the sensing means' determination of battery type.

16. A battery-operated medical device as claimed in claim 15 wherein the switch means is a transistor-based switching means.

17. A battery-operated medical device as claimed in claim 16 wherein the switching means includes a relay.

18. A battery-operated medical device as claimed in claim 17 wherein said predetermined level is such that further use of the battery is possible after manual reconnection.

19. A method of controlling a battery for powering a medical device comprising the steps of sensing one or more properties of the battery to ascertain its charge condition and selectively connecting and disconnecting the battery from the medical device, the method being characterized in that switching occurs upon sensing that the status of the battery has fallen below a predetermined level and wherein manual reconnection of the medical device is possible to permit further use of the battery, the predetermined level being such that the battery is not fully discharged.

20. A method according to claim 19, further comprising the step of emitting a warning signal to warn the user that the battery status is low prior to disconnection of the battery.

21. (canceled)

22. A method according to claim 20 wherein the medical device is a syringe driver.

23. A method according to claim 22 wherein the battery property sensed is one or more of the group selected from voltage, current, temperature, internal resistance, capacitance, time in use, cumulative time of use since new and time since last charge.

24. A method according to claim 23 further comprising sensing an instantaneous voltage reading from the battery and reading this off against a look-up table.

25. A method according to claim 24 further comprising the step of determining where on a known voltage-time characteristic curve the battery is and thereby determining the time remaining before the battery will be substantially discharged.

26. A method according to claim 25 further comprising the step of modifying the estimate of battery life based on characteristics of the medical device.

27. A method according to claim 26 further comprising the step of conducting one or more characterising tests on the battery to determine its type and/or its capacity.

28. A method according to claim 27 further comprising accessing a bank of look-up tables, one of which is selected based on the determination of battery type.

29. A method according to claim 28 wherein said predetermined level is such that further use of the battery is possible after manual reconnection
